(19) United States
(12) Patent Application Publication
(10) Pub. No.: US 2015/0257456 A1
(43) Pub. Date: Sep. 17, 2015

(54) BRA CUP

(71) Applicant: DBAPPAREL OPERATIONS, Rueil-Malmaison (FR)

(72) Inventor: Manon Turlan, Marmagne (FR)

(21) Appl. No.: 14/443,963

(22) PCT Filed: Nov. 13, 2013
(86) PCT No.: PCT/FR2013/052723

§ 371 Date: May 19, 2015

(30) Foreign Application Priority Data
Nov. 19, 2012 (FR) 12/60944

(51) Int. Cl. A41C 3/10; A41C 3/14; B29C 51/14

(52) U.S. Cl. CPC A41C 3/10; B29C 51/145; A41C 3/144; B29K 2075/00

(57) ABSTRACT

A bra cup. The invention concerns a bra cup (10) comprising a first outer skin (12) and a second inner skin (14) which are assembled together in such a way as to form a generally hemispherical-shaped cup (10), characterised in that each skin (12, 14) has a generally convex shape, the inner skin (14) having a substantially shallower convexity than the outer skin (12), such that said skins (12, 14) together define a non-sealed recess (16) filled with air that increases the visual appearance of breast size.

### TECHNICAL FIELD

The invention relates to a light brassiere cup for providing a called <<push-up>> effect.

### BACKGROUND

There are known numerous cups which are designed to make a brassiere with a called <<push-up>> effect, which allows visually increasing the size of the chest by one size or more.

The document FR-A-2972905 describes and represents a structure of a brassiere cup which includes an outer layer and an inner layer which are glued together and which enclose therebetween a pocket containing a malleable silicone gel material.

The pocket is constituted of two thin polymeric films which are sealed to each other in a sealed manner in order to trap the silicone gel.

Although this type of cup fulfills its role of chest-lifter effect, the presence of the filling material of the pocket, gel according to this document, has in particular the drawback of bringing an additional weight to the brassiere which may be detrimental to comfort.

### BRIEF SUMMARY

The invention also aims to address this problem by proposing a lightened cup allowing for a called <<push-up>> effect.

In addition, the invention aims to propose a cup with a simplified design which does not require a sealed pocket for retaining a filling material.

For this purpose, the invention proposes a brassiere cup including a first outer skin and a second inner skin which are assembled together so as to form a generally hemispherical-shaped cup, characterized in that each skin has a generally convex shape, the inner skin having a convexity substantially less deep than the outer skin, so that said skins delimit therebetween a cavity filled with air and which allows visually increasing the chest.

Thus, the cup according to the invention is made with no added filling material in order to lighten the cup.

According to another characteristic, the inner skin and the outer skin are made of polyurethane foam.

In particular, this material has the advantage of being able to adopt a hemispherical shape that is more or less deformable.

In addition, the inner skin and the outer skin are made by thermoforming.

Thermoforming allows making relief shapes in a precise manner. Thermoforming also allows compressing more or less the foam and/or welding it, or hot-gluing to another material such as a textile fabric or another skin made of polyurethane, for example.

Furthermore, the outer skin has a thickness comprised between 8 and 15 millimeters before thermoforming.

Similarly, the inner skin has a thickness comprised between 3 and 10 millimeters before thermoforming.

According to another aspect, the outer skin and the inner skin delimit respectively a first peripheral edge and a second peripheral edge which are assembled together to form the cavity.

This characteristic allows forming a pad without adding any additional material.

In addition, the first peripheral edge and the second peripheral edge are assembled together by thermoforming.

According to another aspect, the inner skin and the outer skin are each dressed with an outer fabric.

This characteristic allows enhancing the comfort and the touch of the cup.

The invention also relates to a brassiere including a pair of cups.

### BRIEF DESCRIPTION OF THE DRAWINGS

Other characteristics and advantages of the invention will become apparent upon reading the detailed description which follows for the understanding of which reference will be made to the appended drawings in which:

FIG. 1 is a front view, which illustrates the inner skin of a cup according to the invention;

FIG. 2 is a back view, which illustrates the outer skin of the cup of FIG. 1;

FIG. 3 is a sectional view, along the axis 3-3 of FIG. 1, which illustrates the cavity delimited by the outer skin and the inner skin.

### DETAILED DESCRIPTION

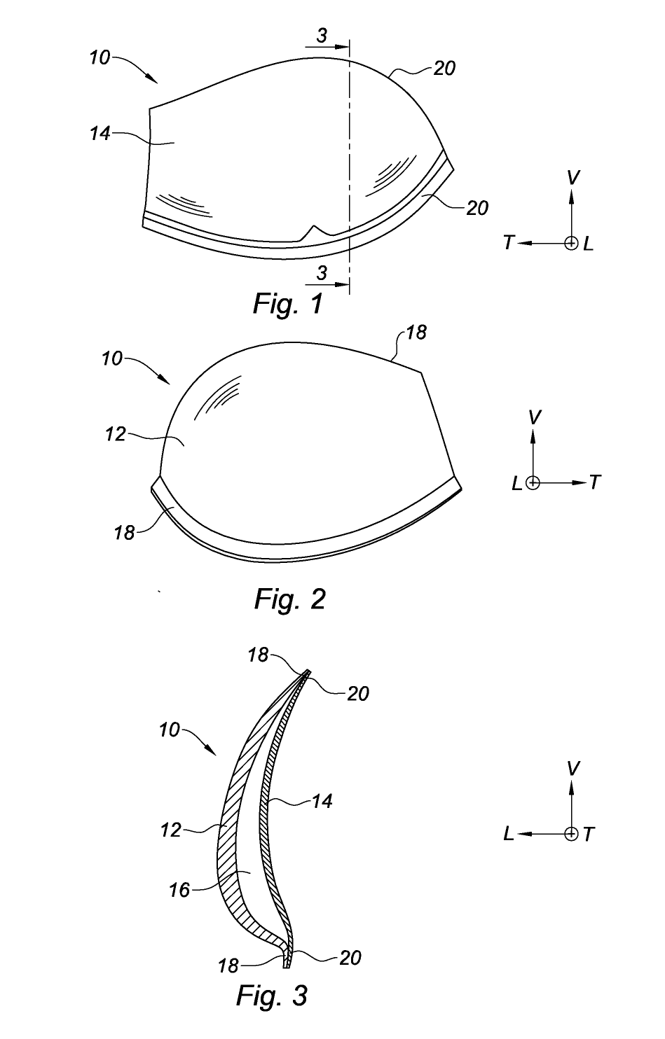

In the description and claims, there will be used, without limitation, the expressions <<upper>> and <<lower>> with reference respectively to the upper portion and the lower portion of FIGS. 1 to 3.

In addition, in order to clarify the description and the claims, there will be adopted, without limitation, the terminology longitudinal, vertical and transverse with reference to the trihedron L, V, T indicated in the Figures.

In FIG. 1, there is represented a brassiere cup 10 which is constituted essentially by a first outer skin 12 and a second inner skin 14.

The outer skin 12 and the inner skin 14 have each a generally convex shape, domed forward along a longitudinal direction.

However, as can be seen in FIG. 3, the inner skin 14 has a convexity substantially less deep than the outer skin 12, that is to say that the radius of curvature of the inner skin 14 is substantially smaller than the radius of curvature of the outer skin 12.

This characteristic allows the inner skin 14 and the outer skin 12 to delimit between them a cavity 16 filled with air and which allows visually increasing the chest.

Advantageously, the shape of each skin 12, 14 is designed so that the major portion of the volume of the cavity 16 is arranged in a lower half of the cup 10, so as to promote the called <<push-up>> effect of the cup 10 on the chest of the person who is wearing it.

However, it may also be considered to create a cavity on the upper half of the cup to allow filling <<voids>> of the upper portion of the breast, in particular for the less domed breasts.

Similarly, the major portion of the volume of the cavity 16 is preferably arranged laterally, at an outer side of the cup, which corresponds to the side of the arm of the person who is wearing the cup, represented at the right side in FIG. 2.

According to another aspect, the inner skin 14 and the outer skin 12 are made of polyurethane foam.

However, without limitation, each skin 12, 14 may be made of any other material allowing to give a generally hemispherical holding to the cup, in particular, of light foam, and more particularly of foam of the ethylene vinyl acetate type, or of polyethylene foam.

Each of the inner skin 14 and the outer skin 12 is made by cutting and by molding of a thermoforming foam plate, each during a separate operation.

The outer skin 12 and the inner skin 14 are delimited respectively by a first peripheral edge 18 and a second peripheral edge 20 which are assembled together to form the cup 10 and the cavity 16.

For this purpose, the outer skin 12 and the inner skin 14 are assembled during an assembling operation which consists of superimposing the outer skin 12 and the inner skin 14 and welding the first edge 18 and the second edge 20 together by thermoforming, so as to give to the cup 10 its generally hemispherical shape.

In a non-limiting manner, the outer skin 12 and the inner skin 14 may be assembled by any other means, in particular by cold or hot gluing, or by means of a peripheral sewing.

According to the embodiment described here, the first peripheral edge 18 and the second peripheral edge 20 are assembled together along their entire length, so as to completely close the cavity 16.

However, without limitation, the first peripheral edge 18 and the second peripheral edge 20 may be assembled together only in part, the cavity 16 not needing to be closed in a sealed manner.

According to another aspect, the outer skin 12 is flexible and slightly extensible, so as to preserve its domed shape and to be deformed, slightly or not at all when the cup 10 is being worn.

To this end, by way of indication, the outer skin 12 has a thickness comprised between eight and fifteen millimeters before thermoforming, and a thickness comprised between one millimeter and fifteen millimeter after thermoforming, the smaller thickness being preferably arranged at the periphery of the cup 10.

Similarly, the inner skin 14 is flexible and slightly extensible, but the inner skin 14 is substantially more flexible than the outer skin.

To this end, the inner skin 14 has a thickness comprised between three and ten millimeters before thermoforming, and a thickness comprised between one half and seven millimeters after thermoforming, the smallest thickness being preferably disposed at the periphery of the cup 10, for example a thickness comprised between one half and one millimeter.

Finally, the inner skin 14 and the outer skin 12 are each dressed with an outer fabric 22, in particular to enhance comfort and for aesthetic reasons.

The cup 10 according to the invention allows forming a chest-increasing pad with no added sealing means, which simplifies the realization of the cup 10.

In addition, the volume of the cavity 16 is filled with only but air, which allows making a cup 10 that is light to wear.

The invention allows making a brassiere (not represented) including a pair of cups 10 as described beforehand, which provides a called <<push-up>> increasing effect, while limiting the increase of the weight in comparison with a conventional brassiere with no added increasing means.

According to a variant of the invention, each cup is obtained by injecting a foam in a mold, such as an ethylene vinyl acetate foam, known as EVA, or a silicone foam, or even a polyurethane foam.

1. A brassiere cup including a first outer skin and a second inner skin which are assembled together so as to form a generally hemispherical-shaped cup,
wherein each skin has a generally convex shape, the inner skin having a convexity substantially less deep than the outer skin, so that said skins delimit therebetween a non-sealed cavity filled with air and which allows visually increasing the chest.

2. The brassiere cup according to claim 1, wherein the inner skin and the outer skin are made of polyurethane foam.

3. The brassiere cup according to claim 1, wherein the inner skin and the outer skin are made by thermoforming.

4. The brassiere cup according to claim 3, wherein the outer skin has a thickness comprised between 8 and 15 millimeters before thermoforming.

5. The brassiere cup according to claim 3, wherein the inner skin has a thickness comprised between 3 and 10 millimeters before thermoforming.

6. The brassiere cup according to claim 1, wherein the outer skin and the inner skin delimit respectively a first peripheral edge and a second peripheral edge which are assembled together to form the cavity.

7. The brassiere cup according to claim 6, wherein the first peripheral edge and the second peripheral edge are assembled together by thermoforming.

8. The brassiere cup according to claim 1, wherein the inner skin and the outer skin are each dressed with an outer fabric.

9. A brassiere including a pair of cups according to claim 1.
